(19) United States
(12) Patent Application Publication
(10) Pub. No.: US 2008/0294939 A1
(43) Pub. Date: Nov. 27, 2008

(54) DEBUGGING DEVICE AND METHOD USING THE LPC/PCI BUS

(75) Inventor: XIANG-YUN KONG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/778,096

(22) Filed: Jul. 16, 2007

(30) Foreign Application Priority Data
May 22, 2007 (CN) 200710200678.4

(51) Int. Cl. G06F 11/22

(52) U.S. Cl. 714/37; 714/E11.145

(57) ABSTRACT

A debug device include a programmable logic device (11) with debugging source codes burnt thereinto; a PCI connector (16) connected with the programmable logic device; a LPC connector (17) connected with the programmable logic device; a first display module (13) connected with the programmable device for showing codes of a port 80; a second display module (14) connected with the programmable device for showing codes of a selected port of 80h to 87h; and a button (15) connected with the programmable logic device for selecting the selected port of 80h to 87h. When the debugging device is used to debug a motherboard with PCI or LPC bus during a POST routine, the debugging device receives datum from the PCI or LPC bus and outputs corresponding datum to the first and second display modules, thereby showing codes of at least one port of 80h to 87h.

### BACKGROUND

1. Field of the Invention

The present invention relates to debugging devices and methods, and more particularly to a debugging device and method using the PCI (Peripheral Component Interconnect) or LPC (Low Pin Count) bus.

2. Description of Related Art

During power-up self test (POST), most computer system BlOSes write status codes to I/O port 80h or 84h. In order to use the codes to diagnose problems, a PCI debugging device is usually adopted and plugged into a PCI expansion slot of a motherboard of the computer system to display codes as test results. If the computer hangs during the POST routine, the PCI debugging device shows the test number it failed on. Then it is easy to detect which hardware is defective according to the POST code.

Some types of motherboards, such as motherboards of a blade server may not have any PCI slots and are not compatible with conventional PCI debugging devices. Motherboards of the blade server may only support LPC bus, causing the PCI debugging device to be disabled. Thus, it is inconvenient to search for and eliminate malfunction errors of these motherboards without PCI interface.

What is needed, therefore, is a debugging device capable of utilizing the PCI or LPC bus and compatible with computers with different standard interfaces.

### SUMMARY OF THE INVENTION

A debugging device for debugging a motherboard with PCI or LPC bus during POST includes a programmable logic device with debugging source codes burnt thereinto; a PCI connector connected with the programmable logic device; a LPC connector connected with the programmable logic device; a first display module connected with the programmable logic device for showing codes of a port 80h; a button connected with the programmable logic device for selecting a port of ports 80h to 87h; and a second display module connected with the programmable device for showing codes of the selected port.

An associated debugging method for debugging the motherboard during POST, includes steps of: selectively connecting the PCI connector or LPC connector of the debugging device to the motherboard; writing datum from the motherboard to the port 80h; transacting the datum of port 80h and displaying the datum via the first display module; operating the button of the debugging device to select one port from ports 80h to 87h; writing datum from the motherboard to the selected port; transacting the datum of the selected port and displaying the datum via the second display module.

Other advantages and novel features will be drawn from the following detailed description of preferred embodiments with attached drawings, in which:

### BRIEF DESCRIPTION OF THE DRAWINGS

FIG. 1 is a block diagram of a debugging device in accordance with a preferred embodiment of the present invention;

FIG. 2 is another block diagram of the debugging device, wherein a detailed configuration of the CPLD of FIG. 1 is illustrated;

FIG. 3 illustrates a detailed configuration of the second display module of FIG. 1; and

FIG. 3 illustrates a debugging process of the debugging device of FIG. 1.

### DETAILED DESCRIPTION OF THE INVENTION

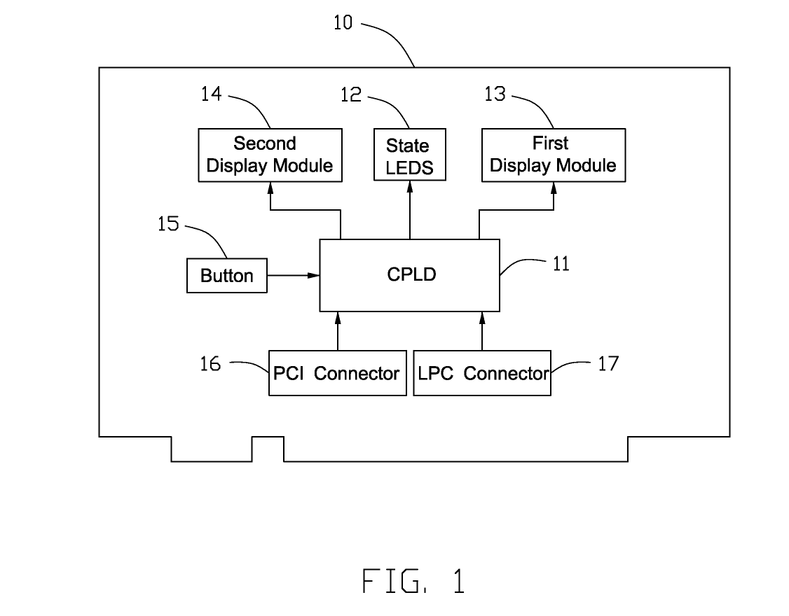

Referring to FIG. 1, a debugging device 10 in accordance with the preferred embodiment of the present invention comprises a CPLD (Complex Programmable Logic Device) 11 with debugging source codes written thereinto, state LEDs 12 connected with the CPLD 11, a first display module 13 connected with the CPLD 11 for showing datum of port 80h, a second display module 14 connected with the CPLD 11 for showing datum of one port of ports 80h to 87h, a button 15 connected with the CPLD 11 and coupled to the second display module 14 to select one port from the ports 80h to 87h for the second display module 14, a PCI connector 16 connected with the CPLD 11, and an LPC connector 17 connected with the CPLD 11. The state LEDs 12 include 10 LEDs for indicating whether respective signals, such as +12V, −12V, +5V, 3.3V, a 3.3V_Standby, reset, clock, frame#, initiator ready, target ready signals are normally on. The PCI connector 16 has 120 pins, and the LPC connector 17 has 9 pins respectively corresponding to LPC_AD0, LPC_AD1, LPC_AD2, LPC_AD3, Vcc, Reset#, Frame#, CLOCK, GND signals send by the CPLD 11.

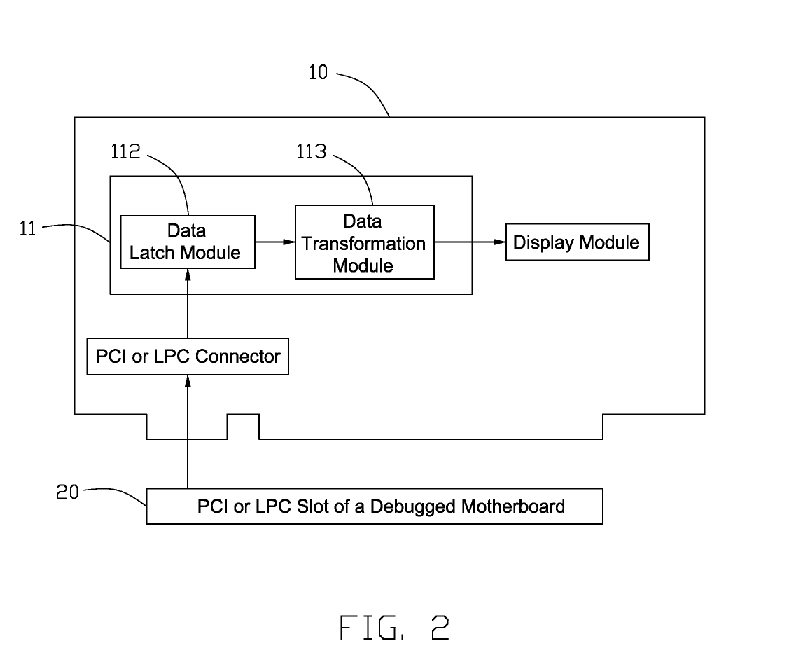

Referring also to FIG. 2, the CPLD 11 includes a data latch module 112, a data transformation module 113. The data latch module 112 is connected with PCI or LPC connectors of the debugging card 10 for receiving datum. The connectors of the debugging card 10 are coupled to the PCI or LPC slot 20 of a motherboard selected for debugging. After datum sent from the motherboard to the debugging device 11 are latched and transformed by the two modules 112, 113, they are displayed via the first, and second display modules 13, 14 to assist users in accurately and conveniently locating problems of the motherboard. The first display module 13 includes dual 7-segment LEDs to display POST code wrote to the port 80h as hexadecimal numbers (not shown).

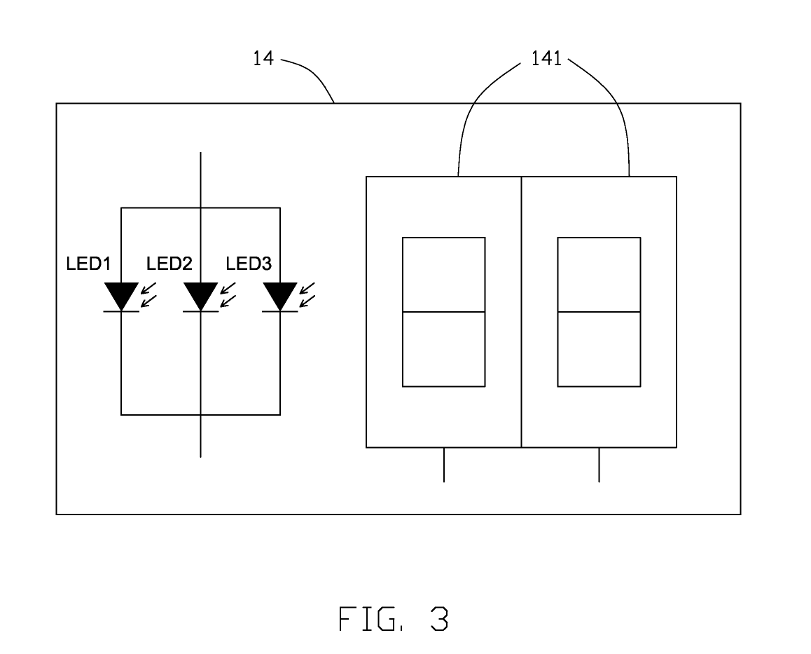

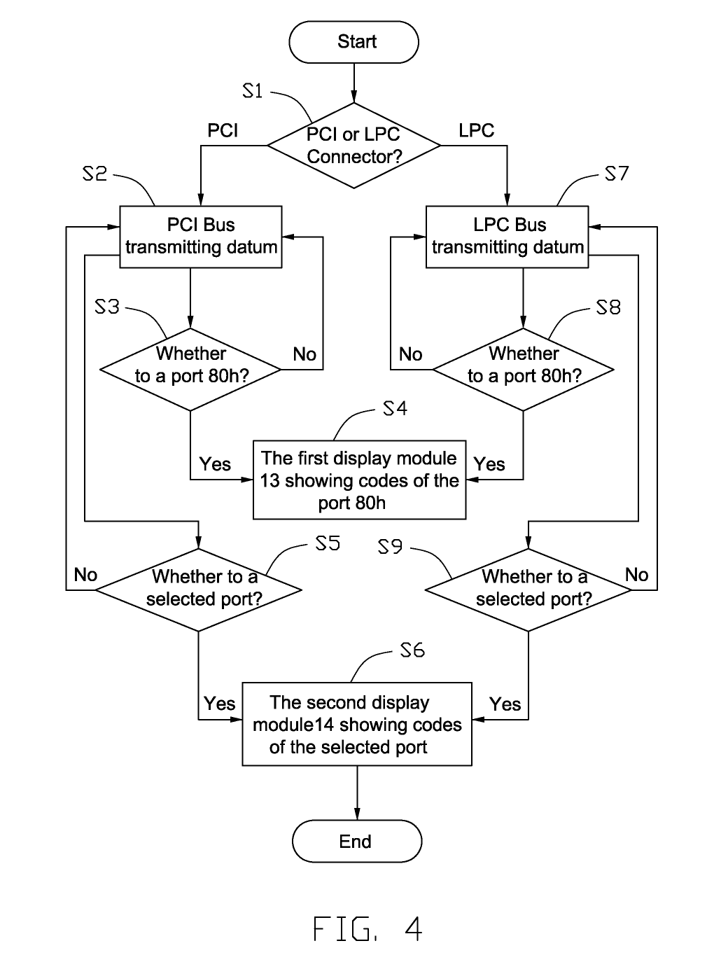

Referring also to FIG. 3, the second display module 14 also includes dual 7-segment LEDs 141 to display POST code wrote to one of the ports 80h to 87h as hexadecimal numbers for showing a more complete POST code. The second display module 14 further comprises an LED1, an LED2, and an LED3 to show which port is selected by the button 15. Initial numbers displayed by the 7-segment LEDs 141 represent codes of the port 84h. After the button 15 is pressed once, the dual 7-segment LEDs 141 of the second display module 14 shows codes of the next port. A table illustrating relationships of the LED1, LED2, and LED3 and a symbol of a selected port is provided below:

| LED1 | LED2 | LED3 | Corresponding PORT |
|---|---|---|---|
| 0 | 0 | 0 | 80h |
| 0 | 0 | 1 | 81h |
| 0 | 1 | 0 | 82h |
| 0 | 1 | 1 | 83h |
| 1 | 0 | 0 | 84h |
| 1 | 0 | 1 | 85h |
| 1 | 1 | 0 | 86h |
| 1 | 1 | 1 | 87h |

(Where ‘0’ represents the LED is on, and ‘1’ represents the LED is off)

Referring also to FIG. 4, a debugging process using the debugging device 10 includes the following steps:
S1: judging whether the PCI connector 16 or the LPC connector 17 of the debugging device 10 should be used; if the PCI connector 16 should be used to be connected with a motherboard with PCI bus, go to S2; if the LPC connector 17 should be used to be connected with a motherboard with LPC bus, go to S7;
S2: if debugging the motherboard with PCI bus during POST, the PCI bus starts to transmit datum;
S3: judging whether corresponding datum is written to port 80h, if yes go to S4; if no, go to S2;
S4: the first display module 13 showing codes of the port 80h;
S5: judging whether corresponding PCI datum is written to a selected port of 80h, 87h, if yes, go to S6; if no, go to S2; selecting a port of 80h to 87h comprising steps of pressing the button 15 of the debugging device 10 to select a port of which the codes are needed to be shown; when the port is selected, the CPLD 11 sends signals to power on or off the three LEDs of the second display module 14 to show a symbol of the selected port;
S6: the second display module 14 showing codes of the selected port as hexadecimal numbers;
S7: if debugging the motherboard with LPC bus during POST, the LPC bus starts to transmit LPC datum;
S8: judging whether corresponding LPC datum is written to port 80h, if yes go to S4; if no, go to S7; and
S9: judging whether corresponding LPC datum is written to a selected port of ports 80h-87h, if yes, go to step 6; if no, go to step 7.
   In addition, before the first or second display modules 13 or 14 showing the datum, the debugging card 10 transacts the POST codes. Transacting the codes or datum comprises steps of: the data latch module 112 latching datum transmitting from the motherboard to the debugging device 10 via the PCI bus or LPC bus; the data transformation module 113 transforming the datum from the data latch module 112; and the data transformation module 113 outputting the datum to the first or second display module.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A debugging device for debugging a motherboard with PCI or LPC bus during POST, comprising:
a programmable logic device with debugging source codes burnt therein;
a PCI connector connected with the programmable logic device;
an LPC connector connected with the programmable logic device;
a first display module connected with the programmable logic device for showing codes of a port 80h;
a button connected with the programmable logic device for selecting a port from ports 80h to 87h; and
a second display module connected with the programmable logic device for showing codes of the selected port;
wherein when the debugging device debug a motherboard with PCI or LPC bus during POST, the debugging device receives datum from the PCI or LPC bus and outputs corresponding datum to the first and second display modules, showing codes of at least one port of the ports 80h to 87h to assist in accurately and conveniently locating problems of the motherboard.

2. The debugging device as described in claim 1, wherein the second display module comprises two 7-segment LEDs to show codes of the selected port, and three LEDs to show which port is selected.

3. The debugging device as described in claim 1, wherein the programmable logic device comprises a data latch module and a data transformation module to latch and then transform datum from the motherboard to the debugging card.

4. The debugging device as described in claim 3, wherein the PCI and LPC connectors of the debugging device are connected with the data latch module for inputting datum to the data latch module.

5. The debugging device as described in claim 4, wherein the first and second display modules are connected with the data transformation module to receive and show datum from the data transformation module.

6. The debugging device as described in claim 1, wherein the programmable logic device is a complex programmable logic device.

7. The debugging device as described in claim 1, wherein the LPC connector has 9 pins to connect with the LPC bus of the motherboard.

8. A debugging method for debugging a motherboard during a POST routine, comprising:
step 1: selectively connecting a PCI connector or a LPC connector of a debugging device as claimed in claim 1 to the motherboard;
step 2: writing datum from the motherboard to a port 80h;
step 3: transacting the datum of port 80h and displaying the datum via a first display module;
step 4: operating a button of the debugging device to select a port from ports 80h to 87h;
step 5: writing datum from the motherboard to the selected port;
step 6: transacting the datum of the selected port and displaying the datum via a second display module.

9. The debugging method as described in claim 8, further comprising a step of judging whether the motherboard is supporting a PCI bus or a LPC bus before step 1.

10. The debugging method as described in claim 8, wherein the step of transacting the datum comprises steps of: latching datum transmitted from the motherboard to the debugging device via the PCI bus or LPC bus; transforming the latched datum; and outputting the datum to the first or second display module.

11. The debugging method as described in claim 8, further comprising a step of displaying a symbol of the selected port via the second display module.

12. The debugging method as described in claim 11, wherein the symbol of the selected port is displayed by three LEDs of the second display module.

13. The debugging method as described in claim 12, further comprising a step of powering on or off the LEDs to display the symbol of the selected port.

14. The debugging device as described in claim 8, wherein codes of the ports 80h to 87h displayed by the first and second display modules are hexadecimal numbers.
